(19) United States
(12) Patent Application Publication
(10) Pub. No.: US 2013/0186547 A1
(43) Pub. Date: Jul. 25, 2013

(54) METHOD FOR MANUFACTURING CONDUCTIVE FILM ROLL

(71) Applicant: Nitto Denko Corporation, Osaka (JP)

(72) Inventors: Nozomi Fujino, Osaka (JP); Hiroyuki Takao, Osaka (JP); Kuniaki Ishibashi, Osaka (JP)

(73) Assignee: NITTO DENKO CORPORATION, Osaka (JP)

(21) Appl. No.: 13/748,694

(22) Filed: Jan. 24, 2013

(30) Foreign Application Priority Data
Jan. 25, 2012 (JP) 2012-012717

(51) Int. Cl. B32B 38/08

(52) U.S. Cl. CPC B32B 38/08
USPC 156/60

(57) ABSTRACT

A method for manufacturing a conductive film roll includes step (A), step (B), and step (C). Step (A) is laminating a first transparent conductor layer and a first metal layer on one surface of a film substrate while rewinding a first roll of the film substrate to obtain a first laminate. Step (B) is conveying the first laminate in air while rewinding a second roll and forming an oxidized coated layer on a surface of the first metal layer to obtain a second laminate. Step (C) is manufacturing a third laminate by laminating a second transparent conductor layer and a second metal layer on the other surface of the film substrate to obtain a fourth roll. Operation effects of the oxidized coated layer prevents blocking.

### BACKGROUND OF THE INVENTION

1. Field of the Invention

The present invention relates to a method for manufacturing a conductive film roll.

2. Description of Related Art

A conventional conductive film which comprises: a film substrate; a plurality of transparent conductor layers formed on both surfaces of the film substrate; and a plurality of metal layers formed on respective transparent conductor layers (for example, JP-A-2011-60146) is known. Such a conductive film is capable of forming wiring at an outer edge of a touch input region and achieving a narrow frame by etching the metal layers and the transparent conductor layers when the conductive film is used for a touch panel. However, there is a problem of blocking of adjacent metal layers in the conductive film when the conductive film is rolled up to obtain a conductive film roll. Blocking is to adhere metal layers to each other by pressure.

### SUMMARY OF THE INVENTION

It is an object of the present invention to solve a problem of blocking of adjacent metal layers in a conductive film which arises in a conductive film roll.

The summary of the present invention is described as below.

In a first preferred aspect, a method for manufacturing a conductive film roll according to the present invention includes: Step A; Step B; and Step C. Step A includes: Step A1; Step A2; Step A3; and Step A4. Step A1 is preparing a first roll. The first roll is obtained by rolling up a film substrate. Step A2 is laminating a first transparent conductor layer on one surface of the film substrate while rewinding the first roll. Step A3 is laminating a first metal layer on the first transparent conductor layer. As a result, a first laminate which comprises the film substrate, the first transparent conductor layer, and the first metal layer is manufactured. Step A4 is manufacturing a second roll by rolling up the first laminate. The second roll is obtained by rolling up the first laminate. Step B includes Step B1 and Step B2. Step B1 is conveying the first laminate in air while rewinding the second roll to form an oxidized coated layer on a surface of the first metal layer. The oxidized coated layer contains an oxide of the first metal layer. As a result, a second laminate which comprises the film substrate, the first transparent conductor layer, the first metal layer, and the oxidized coated layer is manufactured. Step B2 is manufacturing a third roll by rolling up the second laminate. The third roll is obtained by rolling up the second laminate. Step C includes Step C1, Step C2, and Step C3. Step C1 is laminating a second transparent conductor layer on the other surface of the film substrate while rewinding the third roll. Step C2 is laminating a second metal layer on the second transparent conductor layer. As a result, a third laminate which comprises the film substrate, the first transparent conductor layer, the first metal layer, the oxidized coated layer, and the second transparent conductor layer, and the second metal layer is manufactured. Step C3 is manufacturing a fourth roll by rolling up the third laminate. The fourth roll is obtained by rolling up the third laminate. The fourth roll corresponds to a conductive film roll.

In a second preferred aspect of the method according to the present invention, time taken to convey the first laminate in air is 3 minutes to 20 minutes in Step B.

In a third preferred aspect of the method according to the present invention, the first and second metal layers are respectively a copper layer. At this time, the oxidized coated layer contains copper (I) oxide. Copper (I) oxide refers to as oxidized first copper and is represented by Cu₂o.

In a fourth preferred aspect of the method according to the present invention, the oxidized coated layer has a copper (I) oxide content of 50% by weight to 100% by weight.

In a fifth preferred aspect of the method according to the present invention, a material for forming the first transparent conductor layer is any one of indium tin oxide (ITO), indium zinc oxide or indium oxide-zinc composite oxide. A material for forming the second transparent conductor layer is the same as the first transparent conductor layer.

In a sixth preferred aspect of the method according to the present invention, any of the first transparent conductor layer, the first metal layer, the second transparent conductor layer, and the second metal layer is manufactured by a sputtering method.

### ADVANTAGE OF THE INVENTION

According to the present invention, it is possible to solve a problem of blocking of metal layers in a conductive film roll.

### BRIEF DESCRIPTION OF THE DRAWINGS

FIG. 1 is an explanatory drawing of Step A of a manufacturing method according to the present invention;

FIG. 2 is an explanatory drawing of Step B of the manufacturing method according to the present invention;

FIG. 3 is an explanatory drawing of Step C of the manufacturing method according to the present invention;

FIG. 4 (a) is a cross-sectional schematic view of a first laminate according to the present invention;

FIG. 4 (b) is a cross-sectional schematic view of a second laminate according to the present invention; and

FIG. 4 (c) is a cross-sectional schematic view of a third laminate according to the present invention.

### DESCRIPTION OF THE PREFERRED EMBODIMENTS

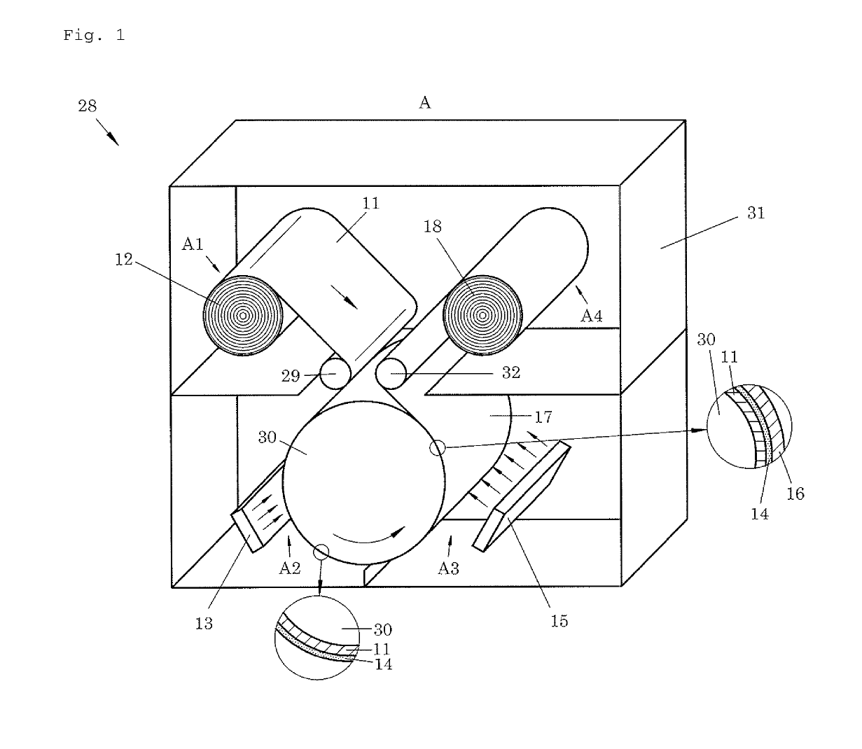

The preferred embodiments of the present invention will now be described with reference to FIGS. 1 to 4. Identical elements in the figure are designated with the same reference numerals.

### [Method for Manufacturing Conductive Film Roll]

A method for manufacturing a conductive film roll of the present invention includes Step A, Step B, and Step C. FIG. 1 shows Step A. Step A includes Step A1, Step A2, Step A3, and Step A4. As shown in FIG. 1, Step A1 is preparing a first roll 12 obtained by rolling up a film substrate 11. Step A2 is laminating a substance which has been scattered from a first target material 13 on one surface of the film substrate 11 while rewinding the first roll 12 to obtain a first transparent conductor layer 14. Next, Step A3 is laminating a substance which has been scattered from a second target material 15 to obtain a first metal layer 16. Subsequently, a first laminate 17 which comprises the film substrate 11, the first transparent conductor layer 14, and the first metal layer 16 is obtained. Next, Step A4 is obtaining a second roll 18 by rolling up the first laminate 17. The second roll 18 is obtained by rolling up the first laminate 17.

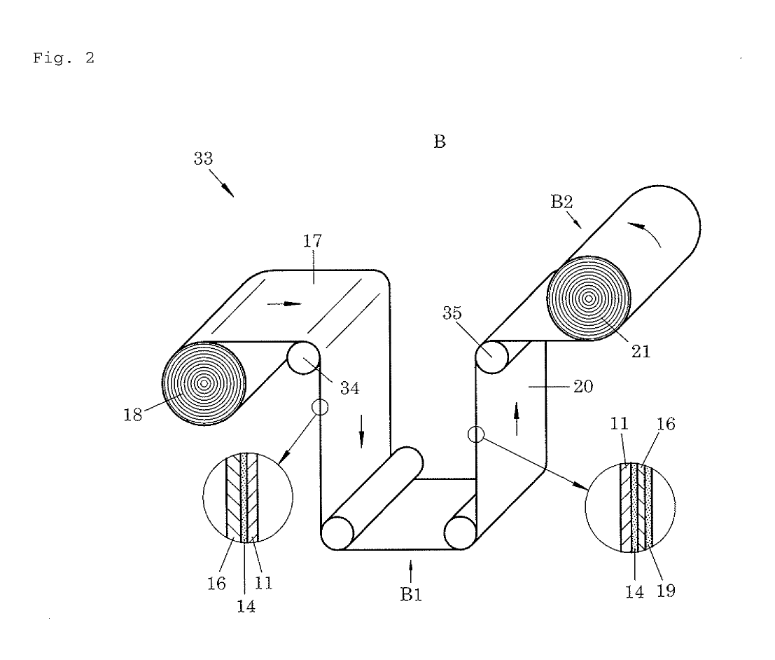

FIG. 2 shows Step B. Step B includes Step B1 and Step B2. As shown in FIG. 2, Step B1 is conveying the first laminate 17 in air while rewinding the second roll 18 to form an oxidized coated layer 19 on a surface of the first metal layer 16. The oxidized coated layer 19 contains an oxide of the first metal layer 16. And a second laminate 20 which comprises the film substrate 11, the first transparent conductor layer 14, the first metal layer 16, and the oxidized coated layer 19 is obtained. Next, Step B2 is rolling up the second laminate 20 to obtain a third roll 21. The third roll 21 is obtained by rolling up the second laminate 20.

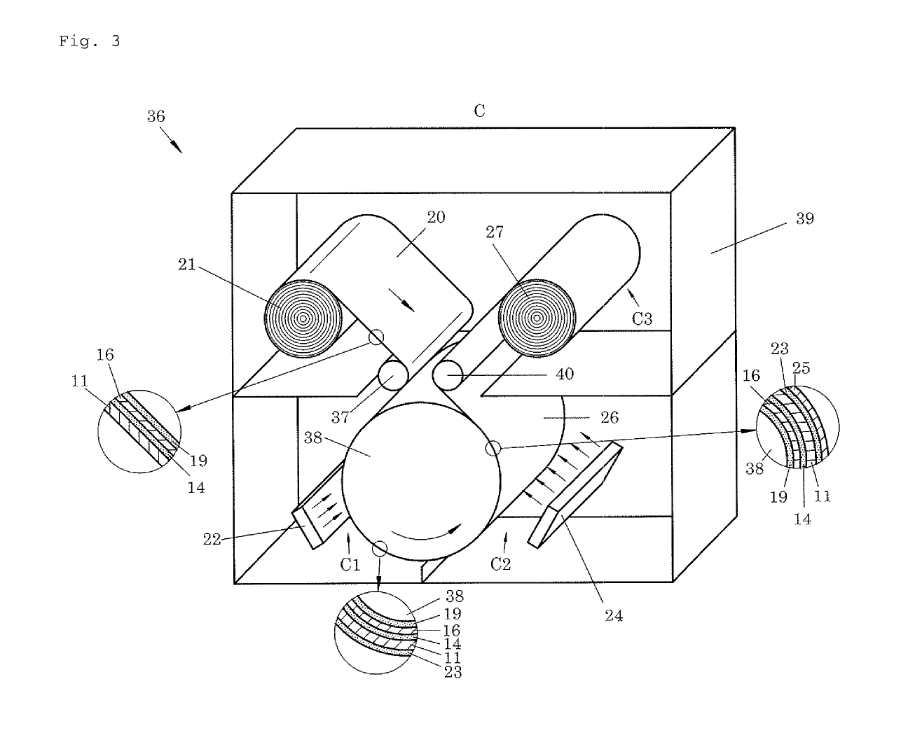

FIG. 3 shows Step C. Step C includes Step C1, Step C2, and Step C3. As shown in FIG. 3, firstly, Step C1 is obtaining a second transparent conductor layer 23 by laminating a substance which has been scattered from a first target material 22 on the other surface of the film substrate 11 while rewinding the third roll 21. Secondly, Step C2 is obtaining a second metal layer 25 by laminating a substance which has been scattered from a second target material 24 on the second transparent conductor layer 23. And a third laminate 26 which comprises the film substrate 11, the first transparent conductor layer 14, the first metal layer 16, the oxidized coated layer 19, the second transparent conductor layer 23, and the second metal layer 25 is obtained. Thirdly, Step C3 is obtaining a fourth roll 27 by rolling up the third laminate 26. The third laminate 26 is rolled up to obtain the fourth roll 27. The fourth roll 27 corresponds to a conductive film roll.

In a conductive film roll (the fourth roll 27) manufactured by the manufacturing method of the present invention, operation effects of the oxidized coated layer 19 prevent blocking of the first metal layer 16 and the second metal layer 25. Accordingly, it is not needed to insert a slip sheet when rolling up the fourth roll 27. The reason why the blocking of the first metal layer 16 and second metal layer 25 is prevented is presumed as below. The adjacent first metal layer 16 and the second metal layer 25 are prevented from being metallically bound to each other because the oxidized coated layer 19 without free electron is interposed between the first metal layer 16 and the second metal layer 25. This makes the first metal layer 16 and the second metal layer 25 difficult to be bound by pressure. The oxidized coated layer 19 is typically an oxidized copper layer.

If the manufacturing method of the present invention includes Step A, Step B, and Step C, the manufacturing method may include the other step between each step or before Step A or after Step C within the range in which effects of the present invention can be obtained.

### [Step A]

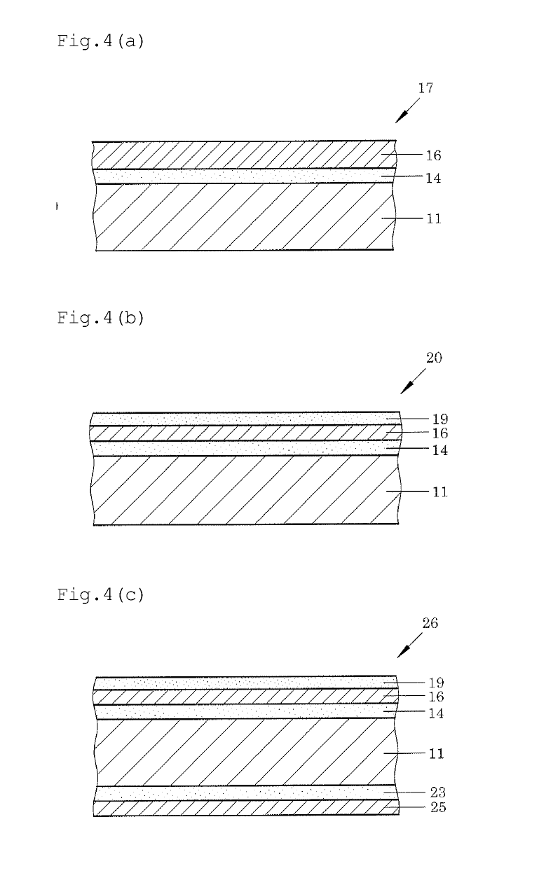

In Step A, a sputtering apparatus 28 shown in FIG. 1 is used. As shown in FIG. 1, Step A is winding the substrate 11 around a forming roll 30 while rewinding the first roll 12 obtained by rolling up the film substrate 11 through a guide roll 29. The first transparent conductor layer 14 is obtained by laminating a transparent conductor which has been scattered from the first target material 13 composed of a transparent conductor on the film substrate 11 wound around the forming roll 30 (Step A2). Metal which has been scattered from the second target material 15 made of metal is laminated on the first transparent conductor layer 14 to obtain the first metal layer 16 (Step A3). The first laminate 17 that comprises the film substrate 11, the first transparent conductor layer 14, and the first metal layer 16 is rolled up through a guide roll 32 to obtain the second roll 18 (Step A4). The second roll 18 is obtained by rolling up the first laminate 17. FIG. 4 (a) shows a schematic cross-sectional view of the first laminate 17. The first laminate 17 is obtained by laminating the first transparent conductor layer 14 and the first metal layer 16 on the film substrate 11.

As shown in FIG. 1, a process of laminating the first transparent conductor layer 14 on the film substrate 11 (Step A2) and a process of laminating the first metal layer 16 on the first transparent conductor layer 14 (Step A3) are preferably performed in one chamber 31 sequentially. It is possible to increase adhesion of the film substrate 11 and the first transparent conductor layer 14 by sequentially performing the aforementioned two processes in the one chamber 31. It is possible to increase adhesion of the film substrate 11 and the first transparent conductor layer 14 by performing the two processes in one chamber 31. Further, it is possible to increase adhesion of the first transparent conductor layer 14 and the first metal layer 16. Moreover, it is possible to minimize foreign matter mixed between the film substrate 11 and the first transparent conductor layer 14. In addition, it is possible to minimize foreign matter mixed between the first transparent conductor layer 14 and the first metal layer 16. It is preferable to laminate the first transparent conductor layer 14 and the first metal layer 16 by the sputtering method. However, it is not limited to the sputtering method but the vapor deposition method or the ion plating method may be used.

The sputtering apparatus 28 shown in FIG. 1 typically comprises: the chamber 31 for making a low-pressure atmosphere (e.g., 1×10⁻⁵ Pa to 1 Pa); the guide roll 29 for conveying the film substrate 11 rewound from the first roll 12; and the forming roll 30 capable of controlling temperature. Further, the sputtering apparatus 28 is arranged so as to be oppositely faced to the forming roll 30 and includes the first target material 13 connected to a direct-current power supply (not illustrated). Furthermore, the second target material 15 arranged so as to be oppositely faced to the forming roll 30 and connected to a direct-current power supply (not illustrated) is provided downstream of the first target material 13. In addition, the sputtering apparatus 28 includes the guide roll 32 for conveying the first laminate 17.

In the sputtering method, for example, a direct-current voltage is applied between the forming roll 30 and the first target material 13 in a low-pressure gas using the sputtering apparatus 28 shown in FIG. 1 to cause the low-pressure gas to be plasma and cation in plasma is caused to collide with the first target material 13 that is a negative electrode. An atom or particles which has/have been scattered from a surface of the first target material 13 due to the collision of cation is/are attached to the film substrate 11. Much the same is true on the second target material 15.

In the sputtering apparatus 28 shown in FIG. 1, typically, a sintering body target material containing indium oxide and tin oxide is used as the first target material 13 and an oxygen-free copper target material is used as the second target material 15. In this case, the first transparent conductor layer 14 made of indium tin oxide (ITO) and the first metal layer 16 made of copper may be sequentially laminated on the film substrate 11.

### [Process B]

In Step B, a rewinding apparatus 33 shown in FIG. 2 is preferably used. As shown in FIG. 2, in Step B, the first laminate 17 is conveyed in air while rewinding the second roll 18 obtained by rolling up the first laminate 17 through a guide roll 34 (Step B1). The oxidized coated layer 19 is formed on a surface of the first metal layer 16 by conveying the first laminate 17 in air. A laminate composed of the film substrate 11, the first transparent conductor layer 14, the first metal layer 16, and the oxidized coated layer 19 after the formation of the oxidized coated layer 19 is referred to as a second laminate 20. The second laminate 20 is rolled up through a guide roll 35 to obtain the third roll 21 (Step B2). The third roll 21 is obtained by rolling up the second laminate 20. In Step B, a surface of the first metal layer 16 is naturally oxidized by an effect of oxygen in air during the conveyance from rewinding the second roll 18 to the rolling up the third roll 21 to form the oxidized coated layer 19. FIG. 4 (b) shows a schematic cross-sectional view of the second laminate 20. The second laminate 20 is obtained by laminating the first transparent conductor layer 14, the first metal layer 16, and the oxidized coated layer 19 on the film substrate 11.

When the first metal layer 16 is a copper layer, a surface of the copper layer is oxidized and copper (I) oxide is formed in Step B1. The copper (I) oxide is monovalent copper oxide represented by a chemical formula; Cu₂O. The oxidized coated layer 19 preferably has a copper (I) oxide content of 50% by weight to 100% by weight, more preferably 60% by weight to 100% by weight. The oxidized coated layer 19 generally contains copper (non-oxidized copper), copper (II) oxide (oxidized second copper: CuO), copper carbonate, and copper hydroxide or the like other than copper (I) oxide. To prevent blocking, the oxidized coated layer 19 preferably has a thickness of 1 nm or greater (for example, 1 nm to 15 nm).

In Step B1, a carrier distance D (not illustrated) from the second roll 18 to the third roll 21 shown in FIG. 2 is preferably 10 m to 150 m, more preferably 20 m to 100 m. A carrier velocity V of the first laminate 17 shown in FIG. 2 is preferably 1 m/minute to 50 m/minute, more preferably 5 m/minute to 20 m/minute. The following equation: carrier time T (minute)=carrier distance D (m)/carrier velocity V (m/minute) indicates the carrier time T of the first laminate 17 shown in FIG. 2. The carrier time T of the first laminate 17 is preferably 3 minutes to 20 minutes, more preferably 5 minutes to 15 minutes. In the case where the carrier time T of the first laminate 17 is less than 3 minutes, there are fears that the oxidized coated layer 19 may not be fully formed on a surface of the first metal layer 16. In this case, there are fears that the blocking prevention effects may be insufficient. In the case where the carrier time T of the first laminate 17 is over 20 minutes, there are fears that productivity of Step B may be lowered. In Step B1, while the atmosphere in the room may be ordinary air (atmosphere) when conveying the first laminate 17, air pressure is preferably 88,000 Pa to 105,000 Pa, air temperature is preferably 10° C. to 50° C., the relative humidity is 15% RH to 95% RH. It is possible to obtain the oxidized coated layer 19 that is enough to prevent the blocking by performing Step B under the aforementioned conditions.

### [Step C]

In Step C, a sputtering apparatus 36 shown in FIG. 3 is preferably used. In Step C, as shown in FIG. 3, the second laminate 20 is rolled around a forming roll 38 with the film substrate 11 placed outside while rewinding the third roll 21 obtained by rolling up the second laminate 20 through a guide roll 37. A transparent conductor which has been scattered from the first target material 22 composed of a transparent conductor is laminated on the film substrate 11 rolled around the forming roll 38 to obtain a second transparent conductor layer 23 (Step C1). Subsequently, metal which has been scattered from the second target material 24 is laminated on the second transparent conductor layer 23 to obtain the second metal layer 25 (Step C2). The third laminate 26 which comprises the obtained film substrate 11, the first transparent conductor layer 14, the first metal layer 16, the oxidized coated layer 19, the second transparent conductor layer 23, and the second metal layer 25 is rolled up through a guide roll 40 to obtain the fourth roll 27 (Step C3). The fourth roll 27 is obtained by rolling up the third laminate 26. The fourth roll 27 corresponds to a conductive film roll. Process conditions for laminating the second transparent conductor layer 23 on the film substrate 11 in Step C1 are similar to process conditions of the aforementioned Step A2. Further, process conditions for laminating the second metal layer 25 on the second transparent conductor layer 23 in Step C2 are similar to process conditions of the aforementioned Step A3. FIG. 4(c) shows a cross-sectional schematic view of the third laminate 26. The third laminate 26 is obtained by laminating the first transparent conductor layer 14, the first metal layer 16, the oxidized coated layer 19 on one surface of the film substrate 11 and laminating the second transparent conductor layer 23 and the second metal layer 25 on the other surface of the film substrate 11.

### [Film Substrate]

As shown in FIGS. 4 (a) to 4(c), the film substrate 11 directly supports the first transparent conductor layer 14 and the second transparent conductor layer 23. The film substrate 11 typically has a thickness of 20 μm to 200 μm. A material for forming the film substrate 11 is preferably polyethylene terephthalate, polycycloolefin or polycarbobnate. The film substrate 11 may have an easily adhering layer (not shown) on a surface thereof to increase adhesion of the film substrate 11 and the first transparent conductor layer 14. Moreover, the film substrate 11 may have an easily adhering layer (not shown) on a surface thereof to increase adhesion of the film substrate 11 and the second transparent conductor layer 23. Furthermore, the film substrate 11 may have an index-matching layer (not shown) on a surface thereof to adjust the reflectivity of the film substrate 11. In addition, the film substrate 11 may have a hard coating layer (not shown) on a surface thereof to prevent surfaces of the film substrate 11 from being scratched.

### [Transparent Conductor Layer]

As shown in FIGS. 4 (a) to 4 (c), the first transparent conductor layer 14 is formed on one surface of the film substrate 11. The first transparent conductor layer 14 is composed of a transparent conductor. The second transparent conductor layer 23 is formed on the other surface of the film substrate 11. The second transparent conductor layer 23 is composed of a transparent conductor. A material for a transparent conductor having a high transmittance in a visible light region and a low surface resistance value per unit area is used. The maximum transmittance in the visible light region is typically 80% or higher. The surface resistance value per unit area is typically 500Ω per square or lower.

A material for forming the first transparent conductor layer 14 is preferably made of any one of indium tin oxide (ITO), indium zinc-oxide or indium oxide-zinc oxide composite oxide. A material for forming the second transparent conductor layer 23 is the same as the above. The first transparent conductor layer 14 preferably has a thickness of 15 nm to 80 nm. The thickness of the second transparent conductor layer 23 is the same as that of the first transparent conductor layer 14.

### [Metal Layer]

As shown in FIGS. 4 (a) to 4 (c), the first metal layer 16 is formed on a surface of the first transparent conductor layer 14. While a material for the first metal layer 16 is preferably copper, the material is not limited to copper. The second metal layer 25 is formed on a surface of the second transparent conductor layer 23. While a material for the second metal layer 25 is preferably copper, the material is not limited to copper. When a conductive film is typically used for a touch panel, the first metal layer 16 is used to form wirings outside a touch input region by etching the first metal layer 16 and the first transparent conductor layer 14. The uses of the second metal layer 25 are the same as those of the first metal layer 16.

The first metal layer 16 preferably has a thickness of 20 nm to 300 nm, more preferably 25 nm to 250 nm. In the case where the first metal layer 16 has a thickness of less than 20 nm, there are fears that the first metal layer 16 may not be a perfect film. And even though a perfect film of the first metal layer 16 is obtained, there are fears that electric resistance may become excessively high. In the case where the thickness of the first metal layer 16 is over 300 nm, there are fears that productivity may be lowered. It is possible to reduce the width of the wirings to be formed by limiting the thickness of the first metal layer 16 within this range. The thickness of the second metal layer 25 is the same as that of the first metal layer 16.

### [Oxidized Coated Layer]

As shown in FIGS. 4 (a) to 4 (c), the oxidized coated layer 19 is formed by naturally oxidizing a surface of the first metal layer 16 in air. The greater the thickness of the oxidized coated layer 19 becomes, the smaller the thickness of the first metal layer 16 becomes. When the first metal layer 16 is made of copper, surfaces of copper are naturally oxidized when conveyed in air in Step B to form copper (I) oxide. The chemical formula of copper (I) oxide is monovalent copper oxide which is represented as Cu₂O. The oxidized coated layer 19 preferably has a copper (I) oxide content of 50% by weight to 100% by weight, more preferably 60% by weight to 100% by weight. In the case where the oxidized coated layer 19 has a copper (I) oxide content of less than 50% by weight, there are fears that sufficient blocking effects may be not obtained. The oxidized coated layer 19 usually contains copper (not oxidized), copper (II) oxide (second copper oxide; CuO), copper carbonate, copper hydroxide or the like other than copper (I) oxide. The oxidized coated layer 19 preferably has a thickness of 1 nm or greater (for example, 1 nm to 15 nm). In the case where the oxidized coated layer 19 has a thickness of less than 1 nm, there are fears that it may be impossible for the oxidized coated layer 19 to fully cover a surface of the first metal layer 16. In this case, there are fears that the blocking prevention effects may not be sufficiently obtained. In the case where the oxidized coated layer 19 has a thickness of over 15 nm, there are fears that carrier time in Step B may be longer, resulting in a decrease in productivity.

### EXAMPLES

### Example

### (Step A)

A first roll 12 composed of a film substrate 11 was set in a sputtering apparatus 28 (FIG. 1) (Step A1). The film substrate 11 is a polycycloolefin film with a thickness of 100 μm and a length of 1,000 m (“ZEONER” (trademark) produced by ZEON CORPORATION). The atmosphere of a chamber 31 of the sputtering apparatus 28 was tuned into an argon gas atmosphere with a pressure of 0.4 Pa. A sintering body target material containing indium oxide and tin oxide was used as a first target material 13 and an oxygen-free copper target material was used as a second target material 15. A first transparent conductor layer 14 was laminated on one surface of the film substrate 11 while rewinding the first roll 12 (Step A2). The first transparent conductor layer 14 was an indium tin oxide layer having a thickness of 20 nm. Subsequently, a first metal layer 16 was laminated on the first transparent conductor layer 14 (Step A3). The first metal layer 16 was a copper layer having a thickness of 50 nm. An obtained first laminate 17 (the film substrate 11, the first transparent conductor layer 14, the first metal layer 16) was rolled up to obtain a second roll 18 (Step A4).

(Step B) The second roll 18 was removed from the sputtering apparatus 28 to be set in a rewinding apparatus (FIG. 2). The second roll 18 was conveyed in air for 5 minutes while being rewound (Step B1). At this time, the air pressure was 102, 700 Pa, the temperature was 24° C., the relative humidity was 60% RH. An oxidized coated layer 19 containing copper (I) oxide was formed on a surface of the first metal layer 16 due to natural oxidization by the conveyance in air. The oxidized coated layer 19 had a thickness of 1.8 nm and had copper (I) oxide content of 80% by weight. Components contained in the oxidized coated layer 19 other than copper (I) oxide were non-oxidized copper, copper (II) oxide, copper hydroxide, and copper carbonate. An obtained second laminate 20 (the film substrate 11, the first transparent conductor layer 14, the first metal layer 16, and the oxidized coated layer 19) was rolled up to obtain a third roll 21 (Step B2).

(Step C) The third roll 21 composed of the second laminate 20 was set in the sputtering apparatus 36 shown in FIG. 3. A sintering body target material containing indium oxide and tin oxide was used as a first target material 22 and an oxygen-free copper target material was used as a second target material 24. A second transparent conductor layer 23 was laminated on the other surface of the film substrate 11 while rewinding the third roll 21 (Step C1). The second transparent conductor layer 23 was an indium tin oxide layer having a thickness of 20 nm. Subsequently, a second metal layer 25 was laminated on the second transparent conductor layer 23 (Step C2). The second metal layer 25 was a copper layer having a thickness of 50 nm. Sputtering conditions for the second transparent conductor layer 23 in Step C1 were the same as those of Step A2. Sputtering conditions for the second metal layer 25 in Step C2 were the same as those of Step A3. An obtained third laminate 26 (the film substrate 11, the first transparent conductor layer 14, the first metal layer 16, the oxidized coated layer 19, the second transparent conductor layer 23, and the second metal layer 25) was rolled up to obtain a fourth roll 27 (Step C3).

Blocking of thus obtained conductive film roll (i.e., the fourth roll 27) was evaluated. No blocking occurred in the obtained conductive film roll (the fourth roll 27) and no scars caused by blocking were seen, even when surfaces of the rewound third laminate 26 were observed.

### Comparative Example

A conductive film roll was prepared in the same manner as in Example 1 except that Step B (a step of conveying the second roll in air while rewinding) was not performed. Blocking occurred in the obtained conductive film roll and there was tearing noise to remove blocking when rewinding the conductive film. A large number of scratches caused by blocking were generated on the surface of the transparent conductor layer.

### [Measuring Method]

### [Thickness and Copper (I) Oxide Content of Oxidized Coated Layer 19]

The thickness and the copper (I) content of the oxidized coated layer 19 were measured using an X-ray Photoelectron Spectroscopy Analyzer (Product name: QuanteraSXM produced by ULVAC-PHI INCORPORATED).

### [Blocking Property of Conductive Film Roll]

The conductive film was rewound from the conductive film roll and the surface of the conductive film was observed to confirm whether or not there is blocking. In the case where blocking occurs, tearing noise is made at the time when rewinding and a large number of scratches caused by blocking were generated on the surface of the transparent conductor layer.

### [Thickness of Transparent Conductor Layer, Thickness of Metal Layer, Thickness of Film Substrate]

The thickness of the transparent conductor layer and the thickness of the metal layer were measured by performing a cross-sectional observation using a transmittance-type electron microscope (produced by Hitachi Ltd., product name: “H-7650”). The thickness of the film substrate was measured using a film meter (produced by Peacock Co., Ltd., product name: Digital Dial Gauge “DG-205”).

### INDUSTRIAL APPLICABILITY

Although the application of the conductive film obtained by the method for manufacturing a conductive film roll of the present invention is not limited, the conductive film obtained by the manufacturing method of the present invention can be preferably used in a touch panel, more specifically, a capacitance-type touch panel.

This application claims priority from Japanese Patent Application No. 2012-012717, which is incorporated herein by reference.

There has thus been shown and described a novel method for manufacturing a conductive film roll which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method for manufacturing a conductive film roll, comprising the steps of: (A), (B), and (C), step (A) comprising the steps of:
(A1) preparing a first roll by rolling up a film substrate;
(A2) laminating a first transparent conductor layer on one surface of the film substrate while rewinding the first roll;
(A3) manufacturing a first laminate by laminating a first metal layer on the first transparent conductor layer; and
(A4) manufacturing a second roll by rolling up the first laminate,
step (B) comprising the steps of:
(B1) conveying the first laminate in air while rewinding the second roll to manufacture a second laminate by forming an oxidized coated layer containing an oxide of the first metal layer on a surface of the first metal layer; and
(B2) manufacturing a third roll by rolling up the second laminate,
step (C) comprising the steps of:
(C1) laminating a second transparent conductor layer on the other surface of the film substrate while rewinding the third roll;
(C2) manufacturing a third laminate by laminating a second metal layer on the second transparent conductor layer; and
(C3) manufacturing a fourth roll by rolling up the third laminate.

2. The method according to claim 1, wherein time taken to convey the first laminate in air is 3 minutes to 20 minutes in the step (B).

3. The method according to claim 1, wherein the first and second metal layers are respectively a copper layer and the oxidized coated layer contains copper (I) oxide.

4. The method according to claim 3, wherein the oxidized coated layer has a copper (I) oxide content of 50% by weight to 100% by weight.

5. The method according to claim 1, wherein a material for forming the first transparent conductor layer and a material for forming the second transparent conductor layer are respectively any one of indium tin oxide (ITO), indium zinc oxide or indium oxide-zinc composite oxide.

6. The method according to claim 1, wherein any of the first transparent conductor layer, the first metal layer, the second transparent conductor layer, and the second metal layer is manufactured by a sputtering method.
